(19) United States
(12) Patent Application Publication
(10) Pub. No.: US 2022/0295824 A1
(43) Pub. Date: Sep. 22, 2022

(54) PROTEIN POWDER

(71) Applicant: Evergrain International BV, Leuven (BE)

(72) Inventors: Sofie FREDERIX, Leuven (BE); Karl GREDEN, Leuven (BE)

(21) Appl. No.: 17/634,859

(22) PCT Filed: Aug. 12, 2020
(86) PCT No.: PCT/EP2020/072682

§ 371 Date: Feb. 11, 2022

(30) Foreign Application Priority Data
Aug. 12, 2019 (BE) BE2019/5525

(51) Int. Cl. A23J 1/12; A23J 1/00; A23L 33/185; A23L 2/66; B01D 61/14; B01D 61/02; B01D 61/58; B01D 69/02; B01D 71/02; B01D 21/26

(52) U.S. Cl. CPC A23J 1/125; A23J 1/005; A23L 33/185; A23L 2/66; B01D 61/147; B01D 61/027; B01D 61/58; B01D 69/02; B01D 71/02; B01D 21/262; A23V 2002/00; B01D 2315/16; B01D 2317/025; B01D 2325/34; B01D 2325/02

(57) ABSTRACT

The present invention provides a process for the production of a protein powder having an improved solubility and taste profile from brewer's spent grain. The process comprises nanofiltration at a specified applied pressure. The present invention also provides a protein powder produced from brewer's spent grain, a process for producing food or beverage products incorporating the protein powder, and food or beverage products comprising the protein powder.

### FIELD OF THE INVENTION

The present invention relates to a process for the production of a protein powder from brewer's spent grain. The present invention also relates to a protein powder produced from brewer's spent grain, a process for producing food or beverage products incorporating the protein powder, and food or beverage products comprising the protein powder.

### BACKGROUND

The use of protein powders and supplements is well known in the art. For example, many people utilise protein powders to make beverages or other foodstuffs as part of a training regimen to provide additional protein for muscle growth. In addition, people may utilise protein supplements when their daily diet is insufficient to satisfy the human body's daily protein requirements. In addition, individuals with specific diets including vegetarians and vegans that do not allow for the consumption of traditional meat-based protein sources may supplement their diets with protein powders to meet their daily requirements.

Traditionally, protein powders and supplements have generally been whey-, soy- or casein-based products. Whey and casein proteins are generally recovered as a by-product from dairy production, with whey being isolated from cheese production and casein being isolated from milk. Soy proteins are isolated from soybeans. While whey, soy and casein-based protein powders and supplements are used to successfully provide beneficial amounts of protein, the latter are not always suited for people having food intolerances or allergies such as lactose intolerance. While plant based protein powders exist that provide less immunogenic effects, these products are typically perceived to have a lesser pleasant taste and are also less soluble than for instance their whey counterparts. As such, the consumer is less inclined to opt for these alternatives.

Brewer's spent grain (BSG) is the most abundant by-product generated in the beer-brewing process. This material comprises malt and grain husks obtained as a solid fraction after the mash filtration or lautering step. To date, brewery by-product has mainly been put to low value uses, in particular as an animal feed.

BSG is rich in nutrients, particularly protein and fibre. Attempts have been made to produce protein powders using BSG, such as disclosed in US 2018/0199593 and US 2018/0199594.

It has been found that protein powders produced using BSG can have a bitter taste and a sub-optimal solubility profile. There is therefore a need for a process for producing protein powder from BSG whereby the taste and solubility profile of the protein powder is improved.

### SUMMARY OF THE INVENTION

The present invention provides an improved process for producing a protein powder from a grain material selected from brewer's spent grain, barley and barley malt. The process comprises:
a) subjecting an aqueous slurry of the grain material to enzymatic protein hydrolysis to produce a liquid protein stream;
b) removing solids from the liquid protein stream;
c) subjecting the liquid protein stream to microfiltration to obtain a microfiltration permeate comprising protein and a microfiltration retentate;
d) subjecting the microfiltration permeate to nanofiltration at an applied pressure of from 1.0 bar (100 kPa) to 8.0 bar (800 kPa) to obtain a nanofiltration permeate and a nanofiltration retentate comprising protein; and
e) processing the nanofiltration retentate to produce the protein powder.

The grain material is preferably brewer's spent grain.

The nanofiltration is preferably carried out at an applied pressure of from 1.3 bar (130 kPa) to 5.0 bar (500 kPa), preferably from 1.3 bar (130 kPa) to 4.5 bar (450 kPa). More preferably, the nanofiltration is carried out at an applied pressure of from 1.3 bar (130 kPa) to 3.3 bar (330 kPa), preferably from 1.4 bar (140 kPa) to 3.2 bar (320 kPa), preferably from 1.5 bar (150 kPa) to 3 bar (300 kPa). The nanofiltration is preferably carried out using a nanofiltration membrane having a molecular weight cut-off (MWCO) of from 500 to 2,000 Da, preferably from 800 to 2,000 Da, preferably from 800 to 1,200 Da.

The microfiltration is preferably carried out using a ceramic microfiltration membrane. The microfiltration membrane preferably has a pore size of from 0.03 to 0.5 μm, preferably from 0.05 to 0.25 μm, preferably from 0.05 to 0.2 μm, preferably from 0.07 to 0.13 μm. The microfiltration preferably comprises a diafiltration step.

The brewer's spent grain preferably comprises spent barley and, optionally, one or more other spent grains or other starchy material selected from rice, corn, sorghum and cassava, preferably selected from rice and corn, preferably rice. It is preferably the spent grain obtained from a brewing process in which the grains used for brewing comprise barley in an amount of at least 30% by weight, preferably at least 40% by weight, preferably at least 60% by weight, preferably at least 70% by weight, based on the total dry matter weight of the grains.

The ratio of grain material (dry matter weight) in the aqueous slurry is preferably from 8:1 to 12:1, preferably from 10:1 to 11:1.

The enzymatic protein hydrolysis preferably comprises treatment with a protease enzyme, preferably an alkaline protease. Preferably, prior to enzymatic protein hydrolysis, the aqueous slurry is subjected to enzymatic starch hydrolysis. The enzymatic starch hydrolysis preferably comprises treatment with a glucoamylase enzyme.

Solids are preferably removed from the liquid protein stream by decantation, preferably by decantation centrifuges.

The grain material may be subjected to particle size reduction before and/or during a).

The solids removed from the liquid protein stream are preferably washed with water and the resulting wash water is combined with the liquid protein stream. The solids removed from the liquid protein stream may be further processed to provide a fibre product.

The microfiltration retentate may be subjected to enzymatic protein hydrolysis in a rehydrolysis step, and the liquid product of the rehydrolysis step can be combined with the liquid protein stream.

The nanofiltration retentate preferably has a total solids content of from 10 to 30% by weight, preferably from 12 to 25% by weight, and a protein content (% dry matter by weight) of at least 80%, preferably at least 85%, as determined by AOAC 990.03 or AOAC 992.15. Processing the nanofiltration retentate to produce the protein powder preferably comprises evaporation to increase the total solids content to a total solids content of from 20 to 55%, preferably from 25 to 55%, preferably from 35 to 55%, preferably from 45 to 55% by weight, preferably from 48 to 52% by weight, and then spray drying to produce the protein powder.

The protein powder produced by the process preferably has a total solids content of at least 90% by weight, preferably at least 93% by weight, and a protein content (% dry matter by weight) of at least 80%, preferably at least 85%, as determined by AOAC 990.03 or AOAC 992.15. Its molecular weight distribution is preferably from 300 Da to 100 kDa, preferably from 300 Da to 30 kDa, with a main peak of from 500 Da to 4.5 kDa, preferably from 2 kDa to 4.5 kDa. Its solubility is preferably at least 50%, preferably at least 75%, in water at a pH of between 3 and 8 and at a temperature of 20° C.; preferably at least 80%, preferably at least 85%, in water at a pH of between 5 and 8 and at a temperature of 20° C.; and preferably at least 90% in water at a pH of between 5.5 and 8 and at a temperature of 20° C.

The present invention also provides a protein powder produced from a grain material selected from brewer's spent grain, barley and barley malt, wherein the protein powder has:
a total solids content of at least 90% by weight;
a protein content (% dry matter by weight) of at least 80%, as determined by AOAC 990.03 or AOAC 992.15; and
a solubility of at least 50% in water at a pH of between 3 and 8 and at a temperature of 20° C.

The protein powder is preferably produced from brewer's spent grain.

The protein powder preferably has a total solids content of at least 93% by weight; a protein content (% dry matter by weight) of at least 85%, as determined by AOAC 990.03 or AOAC 992.15; and a solubility of at least 75% in water at a pH of between 3 and 8 and at a temperature of 20° C. For example, the protein powder may have a solubility of at least 80%, preferably at least 85%, in water at a pH of between 5 and 8 and at a temperature of 20° C., and preferably a solubility of at least 90% in water at a pH of between 5.5 and 8 and at a temperature of 20° C.

The protein powder preferably has a molecular weight distribution of from 300 Da to 100 kDa, preferably from 300 Da to 30 kDa, and a main peak of from 500 Da to 4.5 kDa, preferably from 2 kDa to 4.5 kDa.

The protein powder may have one or more of the following features:
a dispersibility of at least 95%;
a turbiscan stability index (A.U.) of less than 10, preferably less than 8;
a surface tension less than 50 mN/m and/or an interfacial tension of less than 15 mN/m;
a water holding capacity of less than 0.3 g/g and/or an oil holding capacity of less than 3 g/g;

a viscosity of below 1.10⁻¹ Pa·s measured at a temperature of 25° C. and at a shear rate range of between 0.1 s⁻¹ and 1000 s⁻¹;
no gelling capacities;
a fat content of less than 2%, a total fiber content of between 1 and 5%, a total carbohydrate content of between 0 and 7% and a total ash content of between 1 and 8%;
a glutamine concentration of between 15 and 25 g per 100 g of said composition; and/or
a total essential amino acid concentration of between 10 g and 50 g per 100 g of said protein powder, wherein said essential amino acids are histidine, isoleucine, leucine, lysine, methionine, phenylalanine, threonine, tryptophan and valine.

The protein powder is preferably produced according to the process of the present invention.

The present invention also provides a process for producing a food or beverage product, wherein the process comprises incorporating the protein powder of the present invention into the food or beverage product. The present invention also provides a food or beverage product comprising the protein powder according to the present invention.

### DESCRIPTION OF THE DRAWINGS

FIG. 1 shows the solubility profile of compositions according to an embodiment of the current invention. FIG. 1A shows the results of a barley and rice sample, FIG. 1B shows the profile of a barley and corn sample.

FIG. 2 shows the viscosity profile of compositions according to an embodiment of the current invention. FIG. 2A shows the results of a barley and rice sample, FIG. 2B shows the profile of a barley and corn sample. Dotted line: water viscosity.

FIG. 3 shows the molecular weight distribution of a protein powder produced according to the invention.

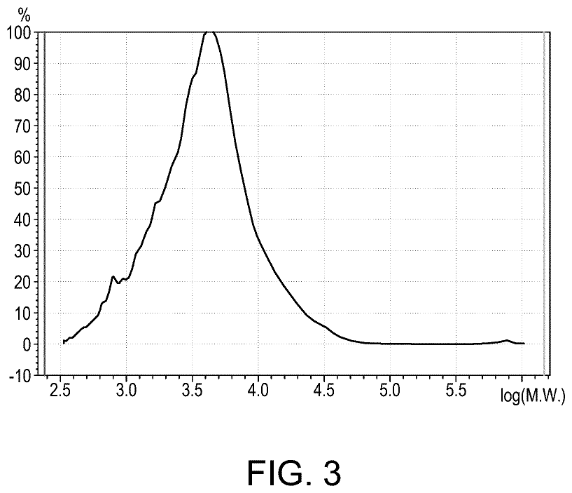

### DETAILED DESCRIPTION

The present invention provides an improved process for the production of a protein powder (also referred to herein as a “powdered protein composition”) from brewer's spent grain; a protein powder; processes for producing food or beverage products incorporating the protein powder; and food or beverage products comprising the protein powder.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein when referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, insofar as such variations are appropriate to perform the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specify the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any or etc. of said members, and up to all said members.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

“Protein content” as used herein refers to the protein content as measured according to the Dumas method (conversion factor 6.25), in particular according to AOAC 990.03 or AOAC 992.15. Other methods known in the art, such as the Kjeldahl method (conversion factor 6.25), may also be used to obtain essentially the same result.

Brewer's Spent Grain:

The starting material for the process of the present invention is a grain material selected from brewer's spent grain, barley and barley malt, and is preferably brewer's spent grain.

Brewer's spent grain is a by-product of the brewing industry following the mashing step. At this point of the brewing process, the soluble fraction (known as ‘wort’) is taken forward for further brewing steps while the insoluble fraction is removed. This insoluble fraction is brewer's spent grain.

The brewer's spent grain used in the process of the present invention is preferably obtained after brewing with grains comprising barley and, optionally, one or more other grains or other starchy materials, for example rice, oats, wheat, corn, sorghum, cassava and/or millet, particularly rice, corn, sorghum and/or cassava, more particularly rice and/or corn. It is most preferred that the brewer's spent grain is obtained after brewing with barley or a mixture of barley and rice or corn, preferably rice.

It is preferred that the grains used for brewing (i.e. the grain mix used at the start of the brewing process) comprises barley in an amount of at least 30% by weight (for example at least 30, 35, 40, 45, 50, 55, 60, 65 or 70% by weight, or any intermediate value), preferably at least 40% by weight, preferably at least 60% by weight, preferably at least 70% by weight, based on the total dry matter weight of the grains.

Process:

The present invention provides an improved process for producing a protein powder from a grain material selected from brewer's spent grain, barley and barley malt. The process comprises:
a) subjecting an aqueous slurry of the grain material to enzymatic protein hydrolysis to produce a liquid protein stream;
b) removing solids from the liquid protein stream;
c) subjecting the liquid protein stream to microfiltration to obtain a microfiltration permeate comprising protein and a microfiltration retentate;
d) subjecting the microfiltration permeate to nanofiltration at an applied pressure of from 1.0 bar (100 kPa) to 8.0 bar (800 kPa) to obtain a nanofiltration permeate and a nanofiltration retentate comprising protein; and
e) processing the nanofiltration retentate to produce the protein powder.

The aqueous slurry is formed by mixing the grain material and water. The ratio of water to grain material (dry matter weight) in the aqueous slurry is preferably from 8:1 to 12:1, preferably from 10:1 to 11:1. The aqueous slurry is preferably formed in a jacketed, mixed tank, preferably with heating means.

The aqueous slurry is subjected to enzymatic protein hydrolysis to produce a liquid protein stream. If desired, the grain material may be subjected to particle size reduction before and/or during this step. Any suitable size reduction technique may be used, for example milling.

Prior to enzymatic protein hydrolysis, the aqueous slurry is preferably subjected to enzymatic starch hydrolysis. The enzymatic starch hydrolysis preferably comprises treatment with a glucoamylase enzyme. Suitable glucoamylase enzymes include those used in the brewing industry and may be obtained from EDC (Enzyme Development Corporation, New York) or Novozymes, for example.

The enzymatic protein hydrolysis is preferably carried out at the natural pH of the aqueous slurry. The pH may be, for example, from about 4.5 to about 6.5 (for example 4.5, 5, 5.5, 6 or 6.5, or any intermediate value).

The enzymatic starch hydrolysis is preferably carried out at a temperature of from about 50° C. to about 65° C. (for example 50, 51, 52, 53, 54, 55, 56, 57, 58, 59, 60, 61, 62, 63 or 65° C., or any intermediate temperature).

The enzymatic starch hydrolysis is preferably carried out for a period of at least about 15 minutes, preferably at least about 20 minutes, and up to about 60 minutes, preferably about 45 minutes. For example, the enzymatic starch hydrolysis may be carried out for a period of 15, 20, 25, 30, 35, 40, 45, 50, 55 or 60 minutes, or any intermediate period.

The enzymatic starch hydrolysis is preferably carried out until at least about 90% by weight, preferably at least about 95% by weight, of the initial starch content has been hydrolysed to sugars (i.e. to glucose and/or to other water-soluble saccharides, including di-saccharides and other short-chain oligosaccharides).

The enzymatic protein hydrolysis preferably comprises treatment with a protease enzyme. The protease enzyme is preferably a food grade protease enzyme, preferably a serine protease. It is preferably an alkaline protease, preferably an endopeptidase, preferably a serine endopeptidase. Suitable protease enzymes may be obtained from Novozymes or EDC (Enzyme Development Corporation, New York), for example.

The enzymatic protein hydrolysis is preferably carried out at a pH of from about 7 to about 10 (for example 7, 7.5, 8, 8.5, 9, 9.5, or any intermediate value), preferably at a pH of about 9. The target pH can be achieved by the addition of an alkali such as sodium and/or potassium hydroxide prior to the treatment with the enzyme.

The enzymatic protein hydrolysis is preferably carried out at a temperature of from about 50° C. to about 75° C. (for example 50, 51, 52, 53, 54, 55, 56, 57, 58, 59, 60, 61, 62, 63, 64, 65, 66, 67, 68, 69, 70, 71, 72, 73, 74 or 75° C., or any intermediate temperature), preferably about 55° C. to about 68° C., preferably about 55° C. to about 65° C.

The enzymatic protein hydrolysis is preferably carried out for a period of at least about 15 minutes, preferably at least about 20 minutes, and up to about 80 minutes, preferably about 60 minutes. For example, the enzymatic protein hydrolysis may be carried out for a period of 15, 20, 25, 30, 35, 40, 45, 50, 55, 60, 65, 70, 75 or 80 minutes, or any intermediate period.

The enzymatic protein hydrolysis is preferably carried out until a degree of hydrolysis (dH) of between 1 and 10 (for example 1, 2, 3, 4, 5, 6, 7, 8, 9 or 10, or any intermediate value) has been reached, preferably until a dH of between 4 and 8 has been reached. As used herein, dH may be determined using the pH-stat method, by adding alkali (e.g. NaOH) and applying the following formula:

$$dH = \frac{( B \times {N}_{B} )}{( α \times {h}_{tot} \times {M}_{P} )} \times 100 wt \%$$

where B is the volume of alkali (mL) consumed, N_{B} is the normality of the alkali, a is the average degree of dissociation of amino acids (0.93 is typically used herein), hₜₒₜ is the total peptide bond content (or amino acid content) in 1 g of protein (meq/g; 9 meq/g is typically used herein) and M_{P} is the mass of the protein present (g).

The enzymatic starch hydrolysis (if carried out) and the enzymatic protein hydrolysis preferably take place in the jacketed, mixed tank in which the aqueous slurry is formed.

Subsequent to enzymatic protein hydrolysis, the enzyme(s) is/are preferably deactivated by increasing the temperature, for example to about 75 to about 90° C. (for example about 75, 76, 77, 78, 79, 80, 81, 82, 83, 84, 85, 86, 87, 88, 89 or 90° C., or any intermediate temperature), preferably to about 80° C., for up to about 35 minutes, for example up to about 25 minutes, for example up to about 10, 15, 20 or 25 minutes, of for any intermediate period of time.

Subsequent to enzymatic protein hydrolysis, solids are removed from the liquid protein stream. The removal of solids preferably takes place by decantation, preferably using decantation centrifuges. Pressure may be applied to the solids in order to maximise the recovery of liquid protein stream, for example using a screw press.

The solids removed from the liquid protein stream are preferably washed with water and the resulting wash water is then combined with the liquid protein stream, again to maximise recovery of proteins.

The solids removed from the liquid protein stream may be further processed to provide a fibre product.

The liquid protein stream is then subjected to microfiltration to obtain a microfiltration permeate comprising protein and a microfiltration retentate. The microfiltration is preferably carried out using a ceramic microfiltration membrane. It has been surprisingly found that ceramic microfiltration membranes are more effective than polymeric membranes in the process of the present invention.

The microfiltration is preferably carried out using a microfiltration membrane having a pore size of from 0.03 to 0.5 μm (for example 0.05, 0.1, 0.15, 0.2, 0.25, 0.3, 0.35, 0.4, 0.45 or 0.5 μm, or any intermediate value), preferably from 0.03 to 0.25 μm, preferably from 0.05 to 0.2 μm, preferably from 0.07 to 0.13 μm (for example 0.07, 0.08, 0.09, 0.10, 0.11, 0.12 or 0.13 μm, or any intermediate value). Suitable microfiltration membranes may be obtained from Pall Corporation. The microfiltration preferably comprises a diafiltration step.

The microfiltration retentate may be subjected to enzymatic protein hydrolysis in a rehydrolysis step, and the liquid product of the rehydrolysis step can be combined with the liquid protein stream. Rehydrolysis of the microfiltration retentate may advantageously improve recovery of proteins.

The microfiltration permeate is subjected to nanofiltration at an applied pressure of from 1.0 bar (100 kPa) to 8.0 bar (800 kPa)) to obtain a nanofiltration permeate and a nanofiltration retentate comprising protein. Applied pressure is a well-known concept in the field of filtration and relates to the pressure at which the feed is fed to the filtration membrane. It is typically controlled by a feed pump and regulated by pressure sensors to ensure that a constant target feed pressure is maintained.

Nanofiltration is typically carried out at an applied pressure significantly greater than the applied pressure according to the present invention, typically at an applied pressure of at least about 10 bar (1,000 kPa) and up to about 40 bar (4,000 kPa). The present inventors have found that, by carrying out nanofiltration at a much lower applied pressure of from 1.0 bar (100 kPa) to 8.0 bar (800 kPa), a protein powder having a more favorable taste and solubility profile can be produced.

The nanofiltration may be carried out at an applied pressure of from 1.0 bar (100 kPa), preferably from 1.3 bar (130 kPa), up to 3, 3.5, 4, 4.5, 5, 5.5, 6, 6.5, 7, 7.5 or 8 bar (up to 300, 350, 400, 450, 500, 550, 600, 650, 700, 750 of 800 kPa), or any intermediate value. The nanofiltration is preferably carried out at an applied pressure of from 1.3 bar (130 kPa) to 5.0 bar (500 kPa), preferably from 1.3 bar (130 kPa) to 4.0 bar (400 kPa), for example at an applied pressure of 1.3, 1.4. 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or 4.0 bar (130, 140, 150, 160, 170, 180, 190, 200, 210, 220, 230, 240, 250, 260, 270, 280, 290, 300, 310, 320, 330, 340, 350, 360, 370, 380, 390 or 400 kPa), or any intermediate value.

The nanofiltration is more preferably carried out at an applied pressure of from 1.3 bar (130 kPa) to 3.3 bar (330 kPa), preferably from 1.4 bar (140 kPa) to 3.2 bar (320 kPa), preferably from 1.5 bar (150 kPa) to 3 bar (300 kPa). For example, nanofiltration may be carried out at an applied pressure of 1.3, 1.4. 1.5, 1.6, 1.7, 1.8, 1.9, 2.0, 2.1, 2.2, 2.3, 2.4, 2.5, 2.6, 2.7, 2.8, 2.9, 3.0, 3.1, 3.2 or 3.3 bar (130, 140, 150, 160, 170, 180, 190, 200, 210, 220, 230, 240, 250, 260, 270, 280, 290, 300, 310, 320 or 330 kPa), or any intermediate value.

The nanofiltration is preferably carried out using a nanofiltration membrane having a molecular weight cut-off (MWCO) of from 500 to 2,000 Da, preferably from 800 to 2,000 Da, preferably from 800 to 1,200 Da. For example, nanofiltration may be carried out using a nanofiltration membrane having a molecular weight cut-off (MWCO) of 500, 600, 700, 800, 900, 1,000, 1,100, 1,200, 1,300, 1,400, 1,500, 1,600, 1,700, 1,800, 1,900 or 2,000 Da, or any intermediate value. Suitable microfiltration membranes may be obtained from MICRODYN-NADIR.

The nanofiltration retentate preferably has a total solids content of from 15 to 25% by weight, preferably from 18 to 22% by weight, and a protein content (% dry matter by weight) of at least 80%, preferably at least 85%, as determined by AOAC 990.03 or AOAC 992.15.

The nanofiltration retentate is processed to produce the protein powder. Processing the nanofiltration retentate to produce the protein powder preferably comprises evaporation to increase the total solids content to a total solids content of from 20 to 55% (for example to 20, 25, 30, 35, 40, 45 or 50%, or any intermediate value), preferably from 25 to 55%, preferably from 35 to 55%, preferably from 45 to 55% by weight (for example to 45, 46, 47, 48, 49, 50, 51, 52, 53, 54 or 55%, or any intermediate value), preferably from 48 to 52% by weight, and then spray drying to produce the protein powder.

The protein powder produced by the process preferably has a total solids content of at least 90% by weight, preferably at least 93% by weight (for example at least 90, 91, 92, 93 or 94%, or any intermediate value), and a protein content (% dry matter by weight) of at least 80%, preferably at least 85% (for example at least 80, 81, 82, 83, 84 or 85%, or any intermediate value), as determined by AOAC 990.03 or AOAC 992.15.

The molecular weight distribution of the protein powder produced by the process is preferably from 300 Da to 100 kDa (for example from 300 Da to 30 kDa, 40 kDa, 50 kDa, 60 kDa, 70 kDa, 80 kDa, 90 kDa or 100 kDa), preferably from 300 Da to 30 kDa, with a main peak of from 500 Da to 4.5 kDa (for example from 500 Da, 600 Da, 700 Da, 800 Da, 900 Da, 1 kDa, 1.1 kDa, 1.2 kDa, 1.3 kDa, 1.4 kDa, 1.5 kDa, 1.6 kDa, 1.7 kDa, 1.8 kDa, 1.9 kDa or 2.0 kDa to 4.5 kDa), preferably from 2 kDa to 4.5 kDa.

Its solubility (as determined according to the method provided further below) is preferably at least 50%, preferably at least 75% (for example at least 50, 55, 60, 65, 70 or 75%, or any intermediate value), in water at a pH of between 3 and 8 and at a temperature of 20° C. Its solubility is preferably at least 80% (for example at least 80, 81, 82, 83, 84, or 85%, or any intermediate value), preferably at least 85%, in water at a pH of between 5 and 8 and at a temperature of 20° C. Its solubility is preferably at least 90% in water at a pH of between 5.5 and 8 and at a temperature of 20° C.

Protein Powder:

The protein powder of the present invention is produced from a grain material selected from brewer's spent grain, barley and barley malt. The protein powder has:
a total solids content of at least 90% by weight;
a protein content (% dry matter by weight) of at least 80%, as determined by AOAC 990.03 or AOAC 992.15; and
a solubility of at least 50% in water at a pH of between 3 and 8 and at a temperature of 20° C.

The protein powder is preferably produced from brewer's spent grain.

The protein powder of the present invention has a particularly favourable taste and solubility profile compared to prior art protein powders derived from brewer's spent grain. It is particularly improved in its bitter taste profile, exhibiting low bitterness.

The protein powder of the present invention has a total solids content of at least 90% by weight, preferably at least 93% by weight (for example at least 90, 91, 92, 93 or 94%, or any intermediate value), and a protein content (% dry matter by weight) of at least 80%, preferably at least 85% (for example at least 80, 81, 82, 83, 84 or 85%, or any intermediate value), as determined by AOAC 990.03 or AOAC 992.15.

The solubility of the protein powder of the present invention (as determined according to the method provided further below) is preferably at least 50%, preferably at least 75% (for example at least 50, 55, 60, 65, 70 or 75%, or any intermediate value), in water at a pH of between 3 and 8 and at a temperature of 20° C. Its solubility is preferably at least 80% (for example at least 80, 81, 82, 83, 84, or 85%, or any intermediate value), preferably at least 85%, in water at a pH of between 5 and 8 and at a temperature of 20° C. Its solubility is preferably at least 90% in water at a pH of between 5.5 and 8 and at a temperature of 20° C.

The molecular weight distribution of the protein powder is preferably from 300 Da to 100 kDa (for example from 300 Da to 30 kDa, 40 kDa, 50 kDa, 60 kDa, 70 kDa, 80 kDa, 90 kDa or 100 kDa), preferably from 300 Da to 30 kDa, with a main peak of from 500 Da to 4.5 kDa (for example from 500 Da, 600 Da, 700 Da, 800 Da, 900 Da, 1 kDa, 1.1 kDa, 1.2 kDa, 1.3 kDa, 1.4 kDa, 1.5 kDa, 1.6 kDa, 1.7 kDa, 1.8 kDa, 1.9 kDa or 2.0 kDa to 4.5 kDa), preferably from 2 kDa to 4.5 kDa.

The protein powder may have one or more of the following features:
a dispersibility of at least 95%;
a turbiscan stability index (A.U.) of less than 10, preferably less than 8;
a surface tension less than 50 mN/m and/or an interfacial tension of less than 15 mN/m;
a water holding capacity of less than 0.3 g/g and/or an oil holding capacity of less than 3 g/g;

a viscosity of below 1.10⁻¹ Pa·s measured at a temperature of 25° C. and at a shear rate range of between 0.1 s⁻¹ and 1000 s⁻¹;
no gelling capacities;
a fat content of less than 2%, a total fiber content of between 1 and 5%, a total carbohydrate content of between 0 and 7% and a total ash content of between 1 and 8%;
a glutamine concentration of between 15 and 25 g per 100 g of said composition; and/or
a total essential amino acid concentration of between 10 g and 50 g per 100 g of said protein powder, wherein said essential amino acids are histidine, isoleucine, leucine, lysine, methionine, phenylalanine, threonine, tryptophan and valine.

The protein powder is preferably produced according to the process of the present invention.

A further description of the protein powder (also referred to as “powdered protein composition”) is provided below.

In one representative embodiment of the present invention, the powdered protein composition obtained from brewer's spent grain has a protein content of at least 75%, at least 80%, more preferably at least 85% on a dry substance basis and a dry matter content of at least 90%, and has a protein solubility of at least 50%, at least 60%, more preferably at least 70% in an aqueous environment at a pH of between 3 and 8 and at least 75%, more preferably at least 80% at a pH of between 5 and 8.

A high protein solubility is advantageous for the further processing and use of said composition, e.g. when being used in beverages.

The test for measuring water-solubility of proteins comprises the preparation of a 2% protein solution in a beaker; agitating said solution for 15 minutes at 500 rpm with a magnetic stirrer; adjusting the pH to a desired pH (pH 3 to 8); and further agitating said solution for 30 minutes. Finally the solution is centrifuged at 15,000 g (15,000 times gravity) during 10 min at 20° C. and the soluble fraction is analysed by the Kjeldahl method (conversion factor of 6.25). The percentage solubility is calculated as:

% solubility=protein content in supernatant/total protein content*100

A protein powder according to representative embodiments of the present invention can be produced using brewer's spent grain from grain sources including, for example, rice, oats, wheat, corn, sorghum, millet, malt and barley. For example, the brewer's spent grain may be obtained after brewing with grains comprising barley and, optionally, one or more other grains or other starchy materials, for example rice, oats, wheat, corn, sorghum, cassava and/or millet, particularly rice, corn, sorghum and/or cassava, more particularly rice and/or corn. It is most preferred that the brewer's spent grain is obtained after brewing with barley or a mixture of barley and rice or corn, preferably rice.

In an embodiment, said brewer's spent grain is a combination of at least barley and rice. In another embodiment, said brewer's spent grain is a combination of at least barley and corn. In another embodiment, the protein composition is derived from barley or (barley) malt.

The protein powder not only provides an additional revenue source to brewing operations but, in addition, possesses various attributes imparted by the brewing and recovery operation which are advantageous for use as a protein supplement. The protein powder of the present invention possesses a number of characteristics that make its use advantageous when used in food and feed, for instance to prepare mixed and blended liquid beverages, pourable food or food articles.

In another or further embodiment, the powdered protein composition according to current invention has a dispersibility of at least 95%, more preferably at least 96%, more preferably at least 97%, more preferably at least 98%, more preferably at least 99%. Dispersibility is defined as the ability of the composition to be dissolved during stirring. While for certain applications, such as for fish feed, a low dispersibility is preferred, a high dispersibility is advantageous when using said protein composition for food applications, such as for instance in beverages. The dispersibility of a composition can be measured by adding a predefined concentration of said composition to an aqueous medium such as water under mixing (e.g. vortex at 500 rpm) for a certain amount of time. The dispersion is subsequently filtered over a filter and the filter and its content are then dried. The dispersibility is calculated based on the proportion of material retained in the filter (undispersed product) per g sample.

In another or further embodiment, said powdered protein composition has a Turbiscan stability index (A.U.) of less than 10, preferably less than 8, preferably less than 7, such as between 1.5 and 6, more preferably between 2 and 5. The latter allows a stable solution of the protein composition when being dissolved in a solution, preferably an aqueous medium. A sedimentation test was performed in a Turbiscan LAB (Formulaction). This equipment measures the proportion of light transmitted through a suspension (transparent suspension) and backscattered (opaque suspension) over time. Sedimentation is signalled by an increase of transmission at the top of the tube (top of suspension is getting more transparent) and an increase of backscattering at the bottom of the tube (bottom of suspension is getting opaquer). An overall stability coefficient is calculated after the test (Turbiscan Stability Index). A TSI of below 10 is considered to be a very stable solution (no sedimentation).

In another or further embodiment, the powdered protein composition of the current invention has a surface tension less than 50 mN/m and/or an interfacial tension of less than 15 mN/m. In a further embodiment, said surface tension is between 30 and 50 mN/m, more preferably between 40 and 45 mN/m. Said interfacial tension may be between 5 and 15 mN/m, more preferably between 10 and 14 mN/m.

The capacity of a composition to decrease surface tension (water/air interface) and interfacial tension (oil/water interface) can be measured with a Kruss tensiometer. It was found that the protein composition according to the current invention decreased the surface tension and interfacial tension more significantly than a caseinate protein isolate. Consequently, the composition has good surface-active properties.

In another or further embodiment, said powdered protein composition has a water holding capacity of less than 0.3 g/g, more preferably between 0.05 g/g and 0.3 g/g; and/or an oil holding capacity of less than 3 g/g, or less than 2.5 g/g, more preferably between 0.5 and 2.5 g/g. In the context of the current invention, water holding capacity (WHC) is defined as the ability of the composition to hold its own or added water during the application of force, pressure, centrifugation, or heating. The composition was found to have hardly or no water holding capacity. On the other hand, said composition has good oil holding capacity.

In another or further embodiment, said powdered protein composition has a viscosity of below 1.10⁻¹ Pa·s, more preferably between 1.10⁻¹ and 0.5. 10⁻¹ Pa·s. Viscosity might be measured by conventional means in the art. In an embodiment, a 10% aqueous solution of said composition was tested and the viscosity profile was measured at a temperature of 25° C. on a shear rate range of between 0.1 s⁻¹ and 1000 s⁻¹. The viscosity of the current composition makes it advantageous when used to prepare mixed and blended liquid beverages.

In an embodiment, the protein composition of the present invention lacks any gelation properties or capacities and will not form a gel when heated and cooled. As such, the composition of the present invention can be advantageously used in preparing protein-enhanced foodstuffs without negatively impacting taste, mouth feel and/or aesthetic appearance. Gelling capacity can be assessed in a rheometer by preparing a 10% solution at pH 7, and heating the solution to 90° C. and cooling it down afterwards. If a gel is formed under these conditions, a strong and sudden rise in storage modulus G′ will be observed and the final storage modulus (“solid behaviour”) is higher than the loss modulus G″ (“liquid behaviour”).

In the context of the current invention, the storage modulus of a 10% solution at pH 7 will remain the same (within the same log range) before and after heating of said solution to 90° C. (for at least 10 minutes) and cooling it down to 25° C.

In another or further embodiment, said powdered protein has a fat content of less than 02%, a total fibre content of between 1 and 5%, a total carbohydrate content of between 0 and 7% and a total ash content of between 1 and 8%.

In another or further embodiment, said powdered protein composition has a glutamine concentration of between 15 and 25 g per 100 mg of said composition. Glutamine is known to be a conditional essential amino acid that is normally present in meat such as beef or chicken and dairy products. Glutamine can be used as a supplement when experiencing heavy physical exertion or during sickness. Studies support the positive effects of the chronic oral administration of the supplement on the injury and inflammation induced by intense aerobic and exhaustive exercise

In another or further embodiment, said powdered protein composition has a total essential amino acid concentration of between 10 g and 50 g per 100 g of said composition, wherein said essential amino acids are histidine, isoleucine, leucine, lysine, methionine, phenylalanine, threonine, tryptophan and valine. As such, the protein powder may provide for a good source of daily amino acid requirements.

Combined with the beneficial sensory characteristics including a pleasant mouth feel and mild flavor that allow the brewer's spent-grain based protein powder to be used alone or as a protein value enhancer within foods intended for human consumption, companion pet foods and in commercial livestock feeds, the brewer's spent-grain based protein powder is a highly advantageous protein supplement.

The current invention also provides a food or beverage product comprising between 1 to 99%, more preferably between 10% and 95%, more preferably at least 15%, more preferably at least 20%, more preferably at least 30%, 40%, 50% of said powdered protein composition according to any of the embodiments as described above. In some embodiments, the protein composition can comprise up to 50% by weight of the food or beverage product, and is preferably used in an amount of 20-40% by weight of the food or beverage product without impacting the flavour profile of the food or beverage product. In some embodiments, the food or beverage product is a beverage or pourable food including, for example, energy drinks, shakes, smoothies, coffee and coffee-based drinks (i.e. latte, mocha, etc.) and teas. In other embodiments, the food or beverage product can comprise muscle building supplements including meal replacement bars and workout drinks. In some embodiments, said food or beverage product can comprise meat substitutes including, for example, meat and meat binder replacements and extruded meat substitutes. In some embodiments, the (protein-enhanced) food or beverage product can comprise coatings and/or bindings for granola, nutrition bars and mueslis. In other embodiments, the protein-enhanced food or beverage product can comprise seasonings for the preparation of bases, gravies, soups and sauces. In some embodiments, the (protein-enhanced) food or beverage product comprises baked goods such as, for example, brownies, cakes, cookies, breads, crackers and the like. In yet other embodiments, the (protein-enhanced) food or beverage product can comprise breakfast products including waffles, pancakes, quick breads, pastries and the like. In some embodiments, the protein-enhanced food or beverage product can comprise dairy products such as, for example, yogurts, cheese spreads, cheese based products and the like. In some embodiments, the (protein-enhanced) food or beverage product can comprise cocoa power extender. In some embodiments, the protein-enhanced food or beverage product can comprise chocolates, candies and confections. In some embodiments, the (protein-enhanced) food stuff can comprise carbohydrate based entrees such as pasta (macaroni and cheese), rice and grains. In some embodiments, the protein-enhanced food or beverage product can comprise dips, spreads and toppings (hummus).

Said food or beverage product may be suited for both human and animal consumption. In an embodiment, said composition is suited to be used as pet food or in pet food formulations.

The protein powder of the present invention may also be described with reference to the following numbered clauses:
1. A powdered protein composition obtained from brewer's spent grain, barley, or barley malt having a protein content of at least 80% on dry substance and a dry matter content of at least 90%, characterized in that said composition has a solubility of at least 50% in an aqueous environment at a pH of between 3 and 8.
2. The powdered protein composition according to clause 1, characterized in that said composition has a solubility of at least 75% in an aqueous environment at a pH of between 3 and 8.
3. The powdered protein composition according to clause 1 or 2, characterized in that said composition has a dispersibility of at least 95%.
4. The powdered protein composition according to any of the previous clauses, characterized in that said composition has a turbiscan stability index (A.U.) of less than 10, preferably less than 8.
5. The powdered protein composition according to any of the previous clauses, having a surface tension less than 50 mN/m and/or an interfacial tension of less than 15 mN/m.
6. The powdered protein composition according to any of the previous clauses having a water holding capacity of less than 0.3 g/g and/or an oil holding capacity of less than 3 g/g.
7. The powdered protein composition according to any of the previous clauses having a viscosity of below 1.10⁻¹ Pa·s measured at a temperature of 25° C. and on a shear rate range of between 0.1 s⁻¹ and 1000 s⁻¹.
8. The powdered protein composition according to any of the previous clauses, wherein the composition has no gelling capacities.
9. The powdered protein composition according to any of the previous clauses, having a fat content of less than 2%, a total fiber content of between 1 and 5%, a total carbohydrate content of between 0 and 7% and a total ash content of between 1 and 8%.
10. The powdered protein composition according to any of the previous clauses, having a glutamine concentration of between 15 and 25 g per 100 g of said composition.
11. The powdered protein composition according to any of the previous clauses, wherein said composition has total essential amino acid concentration of between 10 g and 50 g per 100 g of said composition, wherein said essential amino acids are histidine, isoleucine, leucine, lysine, methionine, phenylalanine, threonine, tryptophan and valine.
12. A food product comprising between 1 to 99% of said powdered protein composition according to any of the clauses 1 to 11
13. Food product according to clause 12, wherein said food product is suitable for humans and/or animals, such as pets.
14. Use of a powdered protein composition according to any of the clauses 1 to 11 as supplement in food products.

### EXAMPLES

The present invention will now be further exemplified with reference to the following examples. The present invention is in no way limited to the given examples or to the embodiments presented in the figures.

### Example 1

Protein powders were prepared according to the following general method, using brewer's spent grain comprising spent barley and either spent corn or spent rice.

The incoming grains were received into a jacketed, mixed tank with water to make 10.5:1 water to dry weight ratio. The resulting slurry was heated to 55° C. and treated with a glucoamylase enzyme (EDC Enzeco® glucoamylase) for 45 minutes to hydrolyse the starch. The pH was then raised to 9 using alkali and maintained for 45 minutes.

The mixture was then treated with a food-grade protease enzyme (EDC Enzeco® alkaline protease L-660) for 20 to 60 minutes at 60° C. to hydrolyse the protein component. Thereafter, the enzymes were deactivated by heating the mixture to 80° C. and holding for up to 25 minutes.

The solids were separated from the liquid protein stream by decanting centrifuges. The liquid protein stream was fed into a microfiltration system (0.1 μm membranes; 70 to 80° C.; suitable membranes available from Pall Corporation).

The permeate from the microfiltration was processed in a nanofiltration system (MWCO of c. 1000 Da; applied pressure 1.5 to 3 bar; suitable membranes available from MICRODYN-NADIR). The output retentate was then subjected to vacuum evaporation to remove water prior to spray drying.

### Example 2

Samples of a protein composition obtained according to Example 1 from brewer's spent grain of barley and rice (SAMPLE A), or barley and corn (SAMPLE B) were analysed as follows. Similar figures were obtained for samples derived from barley alone, or from barley malt (data not shown).

Moisture and Protein Content

Moisture content was measured with a Prepash device (Precisa) based on oven drying (dry to constant weight at 105° C.). The sample moisture was determined at 105° C. over 12 hours. Protein content was measured with automated equipment (Foss) based on the Dumas method (AOAC 992.15). A conversion factor of 6.25 was used.

The sample A has a dry matter content of 95.5% of and protein content of 87.9% (N×6.25) (db). Similar results were obtained for sample B.

TABLE 1
Dry matter content and protein content of sample

| | Dry matter content | Protein content |
|---|---|---|
| | (%) | (% db) (N × 6.25) |
| Sample A | 95.5 | 87.9 |

wb: wet basis; db: dry basis

Protein Solubility

The protein solubility was tested on composition suspensions at 2% protein content. In short, a predefined quantity of protein powder is mixed in an aqueous medium, preferably water, in order to obtain a 2% protein solution. The protein solution is agitated at 500 rpm during 15 min with a magnetic stirrer and the pH is adjusted. The solution is further agitated during 30 minutes and finally centrifuged at 15000 g for 10 minutes at 20° C. The soluble fraction is subsequently analysed by the Kjeldahl method. The protein solubility is calculated by dividing the supernatant protein content by the total protein content and is multiplied by factor 100.

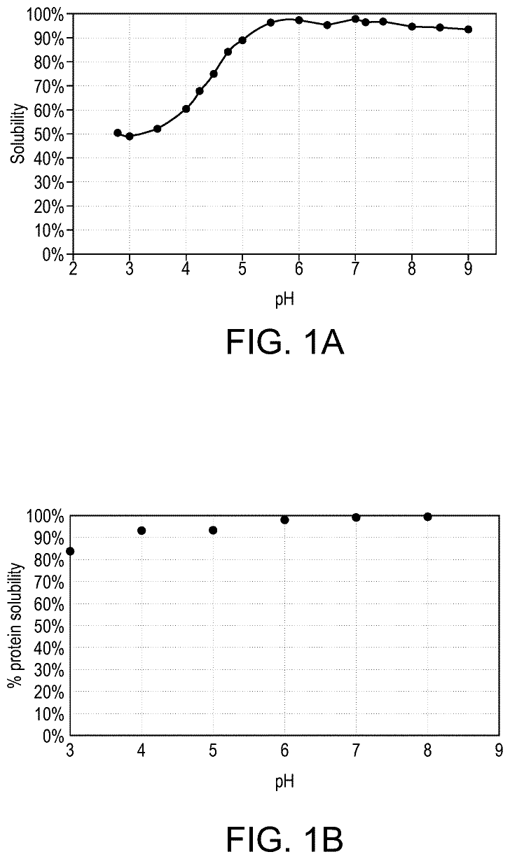

The protein solubility profile of said samples is illustrated in FIGS. 1A (sample A) and 1B (sample B). The protein fraction of the sample is highly soluble (>75%) between pH 5 and pH 8.

Dispersibility

Powder dispersibility was measured using an internal method. 5 g of the sample was added to 100 ml of water under mixing at 500 rpm (vortex). The dispersion was mixed during 5 min. The dispersion was filtrated on a 30 μm filter. The filter and its content was dried at 105° C. during 4 h and weighted. The proportion of material retained in filter (undispersed product) per g sample was calculated.

TABLE 3
Dispersibility of samples

| Sample | % dispersibility |
|---|---|
| Ref 1—instant milk | 99.6 |
| Ref 2—gluten | 17.4 |
| Sample A | 99.3 |
| Sample B | 98.4 |

Sedimentation

A sedimentation test was performed in a Turbiscan. This equipment measures the proportion of light transmitted through a suspension (transparent suspension) and backscattered (opaque suspension) over time. Sedimentation is signaled by an increase of transmission at the top of the tube (top of suspension is getting more transparent) and an increase of backscattering at the bottom of the tube (bottom of suspension is getting opaquer). An overall stability coefficient is calculated after the test (Turbiscan Stability Index). In general, the Turbiscan Stability Index (TSI) is a measure developed by Turbiscan itself. Measures close to 0 indicate that the sample is very stable, with no sedimentation; measures around 10 indicate that some sedimentation is observed whereas measures of 30 and more indicate strong sedimentation.

Hence, a stable powder without sedimentation has a TSI index close to 0. A 1% solution (db) was prepared and placed in a glass cell. A laser beam scanned the sample vertically every minute during 30 min and measured the light transmission and retrodiffusion along the glass cell. The stability of the dispersion (sedimentation, creaming) was measured during 30 min.

The analysed samples were very stable against sedimentation (TSI lower than 10). Starch was used as control.

TABLE 4
Turbiscan Stability Index of sample

| Sample | Turbiscan Stability Index (A.U.) |
|---|---|
| Control—starch | 38.4 |
| Sample A | 2.1 |
| Sample B | 5.9 |

Surface Tension and Interfacial Tension

The capacity of the sample to decrease surface tension (water/air interface) and interfacial tension (oil/water interface) was measured with a Kruss tensiometer. Solutions at 1% and 0.1% protein content were used respectively for interfacial tension and surface tension measurement. Surface tension was measured with a Wilhemy plate. Interfacial tension was measured with a Du Noüy ring. The samples of the current invention decreased surface tension and interfacial tension more importantly than the control (caseinate protein isolate). The samples have good surface-active properties.

TABLE 5

| | Surface tension | Interfacial tension |
|---|---|---|
| Sample | (mN/m) | (mN/m) |
| Sample A | 42.1 | 10.4 |
| Sample B | 42.4 | Not measured |
| Standard (caseinate) | 49.7 | 12.9 |
| Air/water only | 73.0 | — |
| Oil/water only | — | 23.0 |

Water Holding Capacity and Oil Holding Capacity

The water and oil holding capacities were measured by adding said sample in oil and water at a concentration of 20 mg/ml of dry matter. Suspensions were blended 1 hour under stirring. After centrifugation at 15000 g during 10 min, the water or oil content in the pellet was measured and compared with the initial weight of material. The results are expressed as the number of times that sample is able to retain its weight in water or oil. The analyzed sample has no water holding capacity. It has an oil holding capacity of 1.9 g/g.

TABLE 7
Water and Oil Holding Capacity of sample

| Sample | WHC (g/g) | OHC (g/g) |
|---|---|---|
| Sample A | 0.1 | 1.9 |
| Sample B | 0.3 | 1.8 |
| Reference | 1.6 (faba bean) | 1.5 (caseinate) |

Viscosity

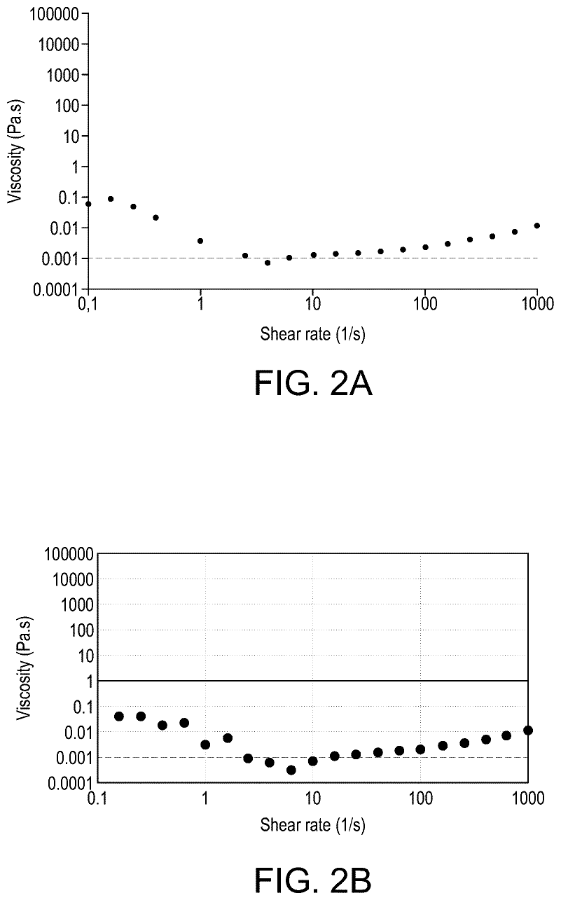

Rheological analysis was performed at 25° C. on a DHR-2 rheometer (TA) with a vane cup geometry. A 10% solution (dry matter based) was used. Viscosity profile was measured on a shear rate range between 0.1 s⁻¹ and 1 000 s⁻¹. Sample viscosity profile in 10% protein solution are presented in FIGS. 2A and B. The measured viscosity is very low, (approximately 10-2 Pa.s) which is slightly higher than water alone. The viscosity is more or less independent of the shear rate, which corresponds to Newtonian behaviour.

Minimum Gelling Concentration

The minimum gelling concentration was measured by preparing solutions from 2% to 20% of sample content in test tubes. After solubilization, solutions were heated 1 h in a water-bath at 85° C. and then cooled 2h at 4° C. Said solution was considered to have formed a gel if it behaved like a liquid before heating (ie free-flowing) and did not flow when test-tube was put upside-down after heating. The samples did not gel at 85° C. between 2% and 20% under the conditions tested.

Gelling Capacity

Gelling capacity was measured on a DHR-2 rheometer (TA) with a 40 mm plate/plate geometry and was assessed by preparing a 10% protein solution, heating it up to 90° C. and cooling it down to 25° C. If the sample is able to form a gel in these conditions of concentration and pH, a strong and sudden rise of storage modulus G′ is observed and final storage modulus (“solid behaviour”) is higher than loss modulus G″ (“liquid behaviour”). With the analyzed samples, the storage modulus G′ was stable during heating and only marginally increased during cooling between 40° C. to 25° C. Moreover, after cooling G′≈G″. This signals that the samples have no gelling capacity under the conditions tested.

1. A process for producing a protein powder from a grain material selected from brewer's spent grain, barley and barley malt, wherein the process comprises:
a) subjecting an aqueous slurry of the grain material to enzymatic protein hydrolysis to produce a liquid protein stream;
b) removing solids from the liquid protein stream;
c) subjecting the liquid protein stream to microfiltration to obtain a microfiltration permeate comprising protein and a microfiltration retentate;
d) subjecting the microfiltration permeate to nanofiltration at an applied pressure of from 1.0 bar (100 kPa) to 8.0 bar (800 kPa) to obtain a nanofiltration permeate and a nanofiltration retentate comprising protein; and
e) processing the nanofiltration retentate to produce the protein powder.

2. A process according to claim 1, wherein the grain material is brewer's spent grain.

3. A process according to claim 1 or 2, wherein the nanofiltration is carried out at an applied pressure of from 1.3 bar (130 kPa) to 5.0 bar (500 kPa), preferably from 1.3 bar (130 kPa) to 4.0 bar (400 kPa).

4. A process according to claim 3, wherein the nanofiltration is carried out at an applied pressure of from 1.3 bar (130 kPa) to 3.3 bar (330 kPa), preferably from 1.4 bar (140 kPa) to 3.2 bar (320 kPa), preferably from 1.5 bar (150 kPa) to 3 bar (300 kPa).

5. A process according to any preceding claim, wherein the nanofiltration is carried out using a nanofiltration membrane having a molecular weight cut-off (MWCO) of from 500 to 2,000 Da, preferably from 800 to 2,000 Da, preferably from 800 to 1,200 Da.

6. A process according to any preceding claim, wherein the microfiltration is carried out using a ceramic microfiltration membrane.

7. A process according to any preceding claim, wherein the microfiltration is carried out using a microfiltration membrane having a pore size of from 0.03 to 0.5 μm, preferably from 0.05 to 0.25 μm, preferably from 0.05 to 0.2 μm, preferably from 0.07 to 0.13 μm.

8. A process according to any preceding claim, wherein the microfiltration comprises a diafiltration step.

9. A process according to any preceding claim, wherein the brewer's spent grain comprises spent barley and, optionally, one or more other spent grains or other starchy material selected from rice, corn, sorghum and cassava, preferably selected from rice and corn, preferably rice.

10. A process according to any preceding claim, wherein the brewer's spent grain is the spent grain obtained from a brewing process in which the grains used for brewing comprise barley in an amount of at least 30% by weight, preferably at least 40% by weight, preferably at least 60% by weight, preferably at least 70% by weight, based on the total dry matter weight of the grains.

11. A process according to any preceding claim, wherein the ratio of water to grain material (dry matter weight) in the aqueous slurry is from 8:1 to 12:1, preferably from 10:1 to 11:1.

12. A process according to any preceding claim, wherein the enzymatic protein hydrolysis comprises treatment with a protease enzyme, preferably an alkaline protease.

13. A process according to any preceding claim, wherein, prior to enzymatic protein hydrolysis, the aqueous slurry is subjected to enzymatic starch hydrolysis.

14. A process according to claim 13, wherein the enzymatic starch hydrolysis comprises treatment with a glucoamylase enzyme.

15. A process according to any preceding claim, wherein solids are removed from the liquid protein stream by decantation, preferably by decantation centrifuges.

16. A process according to any preceding claim, wherein the grain material is subjected to particle size reduction before and/or during a).

17. A process according to any preceding claim, wherein the solids removed from the liquid protein stream are washed with water and the resulting wash water is combined with the liquid protein stream.

18. A process according to any preceding claim, wherein the solids removed from the liquid protein stream are further processed to provide a fibre product.

19. A process according to any preceding claim, wherein the microfiltration retentate is subjected to enzymatic protein hydrolysis in a rehydrolysis step, and wherein the liquid product of the rehydrolysis step is combined with the liquid protein stream.

20. A process according to any preceding claim, wherein the nanofiltration retentate has a total solids content of from 10 to 30% by weight, preferably from 12 to 25% by weight, and a protein content (% dry matter by weight) of at least 80%, preferably at least 85%, as determined by AOAC 990.03 or AOAC 992.15.

21. A process according to any preceding claim, wherein processing the nanofiltration retentate to produce the protein powder comprises evaporation to increase the total solids content to a total solids content of from 20 to 55%, preferably from 25 to 55%, preferably from 35 to 55%, preferably from 45 to 55% by weight, preferably from 48 to 52% by weight, and then spray drying to produce the protein powder.

22. A process according to any preceding claim, wherein the protein powder has a total solids content of at least 90% by weight, preferably at least 93% by weight, and a protein content (% dry matter by weight) of at least 80%, preferably at least 85%, as determined by AOAC 990.03 or AOAC 992.15.

23. A process according to any preceding claim, wherein the protein powder has a molecular weight distribution of from 300 Da to 100 kDa, preferably from 300 Da to 30 kDa, and a main peak of from 500 Da to 4.5 kDa, preferably from 2 kDa to 4.5 kDa.

24. A process according to any preceding claim, wherein the protein powder has a solubility of at least 50%, preferably at least 75%, in water at a pH of between 3 and 8 and at a temperature of 20° C., and preferably has a solubility of at least 80%, preferably at least 85%, in water at a pH of between 5 and 8 and at a temperature of 20° C., and preferably has a solubility of at least 90% in water at a pH of between 5.5 and 8 and at a temperature of 20° C.

25. A protein powder produced from a grain material selected from brewer's spent grain, barley and barley malt, wherein the protein powder has:
a total solids content of at least 90% by weight;
a protein content (% dry matter by weight) of at least 80%, as determined by AOAC 990.03 or AOAC 992.15; and
a solubility of at least 50% in water at a pH of between 3 and 8 and at a temperature of 20° C.

26. A protein powder according to claim 25, wherein the grain material is brewer's spent grain.

27. A protein powder according to claim 25 or 26, wherein the protein powder has:
a total solids content of at least 93% by weight;
a protein content (% dry matter by weight) of at least 85%, as determined by AOAC 990.03 or AOAC 992.15; and
a solubility of at least 75% in water at a pH of between 3 and 8 and at a temperature of 20° C.

28. A protein powder according to claim 27, wherein the protein powder has a solubility of at least 80%, preferably at least 85%, in water at a pH of between 5 and 8 and at a temperature of 20° C., and preferably has a solubility of at least 90% in water at a pH of between 5.5 and 8 and at a temperature of 20° C.

29. A protein powder according to any of claims 25-28, wherein the protein powder has a molecular weight distribution of from 300 Da to 100 kDa, preferably from 300 Da to 30 kDa, and a main peak of from 500 Da to 4.5 kDa, preferably from 2 kDa to 4.5 kDa.

30. A protein powder according to any of claims 25-29, wherein the protein powder has one or more of the following features:
a dispersibility of at least 95%;
a turbiscan stability index (A.U.) of less than 10, preferably less than 8;
a surface tension less than 50 mN/m and/or an interfacial tension of less than 15 mN/m;
a water holding capacity of less than 0.3 g/g and/or an oil holding capacity of less than 3 g/g;
a viscosity of below 1.10⁻¹ Pa·s measured at a temperature of 25° C. and at a shear rate range of between 0.1 s⁻¹ and 1000 s⁻¹;
no gelling capacities;
a fat content of less than 2%, a total fiber content of between 1 and 5%, a total carbohydrate content of between 0 and 7% and a total ash content of between 1 and 8%;
a glutamine concentration of between 15 and 25 g per 100 g of said composition; and/or
a total essential amino acid concentration of between 10 g and 50 g per 100 g of said protein powder, wherein said essential amino acids are histidine, isoleucine, leucine, lysine, methionine, phenylalanine, threonine, tryptophan and valine.

31. A protein powder according to any of claims 25-30, wherein the protein powder is produced according to the process of any of claims 1-24.

32. A process for producing a food or beverage product, wherein the process comprises incorporating a protein powder according to any of claims 25-31 into the food or beverage product.

33. A food or beverage product comprising a protein powder according to any of claims 25-31.
